(19) United States
(12) Patent Application Publication
(10) Pub. No.: US 2013/0174529 A1
(43) Pub. Date: Jul. 11, 2013

(54) Stem Deflector Mount

(71) Applicant: Lankota Group, Inc., Huron, SD (US)

(72) Inventors: Brian J. Hyronimus, Huron, SD (US); Lance C. Tschetter, Huron, SD (US)

(73) Assignee: Lankota Group, Inc., Huron, SD (US)

(21) Appl. No.: 13/769,758

(22) Filed: Feb. 18, 2013

Related U.S. Application Data
(63) Continuation-in-part of application No. 13/737,030, filed on Jan. 9, 2013.
Application No. 13/737,030 is a continuation of application No. 13/348,270, filed on Jan. 11, 2012.

(51) Int. Cl. A01D 75/00; F16C 11/10

(52) U.S. Cl. CPC A01D 75/00; F16C 11/10
USPC 56/314; 403/103; 29/525.01

(57) ABSTRACT

A method and apparatus for attaching a toolbar with at least one mounted stem deflector to a combine head. The apparatus includes at least one head bracket that attaches to the combine head. The apparatus also includes at least one rotatable member that couples to the toolbar. A position of the at least one rotatable member is adjustable relative to the combine head. The apparatus also includes an actuator that adjusts the position of the at least rotatable member relative to the combine head.

### CROSS-REFERENCE TO RELATED APPLICATION

The present application is a continuation in part of and claims priority of U.S. patent application Ser. No. 13/737,030, filed Jan. 9, 2013, which is a continuation of and claims priority of U.S. patent application Ser. No. 13/348,270, filed Jan. 11, 2012, the contents of which are hereby incorporated by reference in their entirety.

### FIELD

The present embodiments relate generally to agricultural equipment and more particularly to mounts for stem deflectors that are utilized with crop harvesting machines, for example.

### BACKGROUND

Stem deflectors are utilized with crop harvesting machines such as combine harvesters. A combine harvester, or simply combine, is a machine that harvests grain crops. It combines into a single operation a process that previously required three separate operations (reaping, threshing, and winnowing). Among the crops harvested with a combine are wheat, oats, rye, barley, corn (maize), soybeans and flax (linseed). Combines are equipped with removable heads that are designed for particular crops.

Stem deflectors are units that mount to a rear of a combine head (for example, a corn head). A stem deflector bends over the remaining stem after the head has harvested the ear of corn, for example. Stem deflectors typically include springs that bias a shoe against the earth for bending or crushing the stems as the combine travels in a forward direction.

Stem deflectors typically mount to the rear of the combine head via a toolbar mounting system. In one current mounting configuration, the stem deflectors mount to a toolbar, connected to the head, by way of a mounting bracket. When the combine harvester is driven down highways, for example, the head must be detached from the combine and placed on a header trailer because a width of a typical head exceeds width restrictions for highway vehicles. When the head with the mounted stem deflectors is placed on a trailer, some of the stem deflectors invariably interfere with axles/tires of the trailer. Therefore, a user has to detach any interfering stem deflectors from the toolbar and store them away from the trailer axles/tires. This process of detaching interfering stem deflectors during transportation, and the subsequent re-mounting of the detached stem deflectors, is inconvenient and time consuming.

Exemplary embodiments of the disclosure address these and other problems, and offer other advantages over the prior art.

### SUMMARY

One embodiment is directed to an apparatus for rotatably mounting at least one stem deflector to a combine head. The apparatus includes at least one head bracket that attaches to the combine head. The apparatus also includes at least one rotatable member that couples to the at least one stem deflector. A position of the at least one rotatable member is adjustable relative to the combine head. A hydraulic actuator couples to the combine head and couples to the at least one stem deflector. The hydraulic actuator adjusts the position of the at least rotatable member relative to the combine head.

Another embodiment is directed to a method of attaching a toolbar with at least one mounted stem deflector to a combine head. The method includes rotatably coupling the toolbar to the combine head through a rotatable member. The method also includes providing a hydraulic actuation mechanism to move the rotatable member through a plurality of adjustment positions.

Yet another embodiment is directed to an apparatus for attaching a toolbar with at least one mounted stem deflector to a combine head. The apparatus includes at least one head bracket that attaches to the combine head. The apparatus also includes at least one rotatable member that couples to the toolbar. A position of the at least one rotatable member is adjustable relative to the combine head. The apparatus also includes an actuator that adjusts the position of the at least rotatable member relative to the combine head.

This summary is not intended to describe each disclosed embodiment or every implementation of the stem deflector mount. Many other novel advantages, features, and relationships will become apparent as this description proceeds. The figures and the description that follow more particularly exemplify illustrative embodiments.

### BRIEF DESCRIPTION OF THE DRAWINGS

FIG. 1A is a diagrammatic illustration of a combine harvester with a connected head to which a stem deflector is coupled.

FIG. 1B is a diagrammatic illustration of a portion of a combine head with an attached toolbar to which multiple stem deflectors are rotatably coupled with the help of stem deflector mounts in accordance with one embodiment.

FIGS. 2A and 2B are perspective views of a stem deflector mount in accordance with one embodiment.

FIG. 2C is a front view of the stem deflector mount of FIGS. 2A and 2B.

FIG. 2D is an exploded view of the stem deflector mount of FIGS. 2A and 2B.

FIG. 3A is a diagrammatic illustration showing the stem deflector mount of FIGS. 2A and 2B with its base attached to a toolbar and its mounting arm attached to a stem deflector, the mounting arm in held in place in a first position.

FIG. 3B is a diagrammatic illustration of the apparatus shown in FIG. 3A with the mounting arm held in place in a second position.

FIG. 4 is a diagrammatic illustration of a stem deflector mount in accordance of another embodiment.

FIG. 5A is a diagrammatic illustration of a hydraulic stem deflector mount in accordance with one exemplary embodiment.

FIG. 5B is an exploded view of the hydraulic stem deflector mount of FIG. 5A.

FIG. 5C is a diagrammatic illustration of a hydraulic actuator control system utilized in one embodiment.

FIGS. 5D and 5E are diagrammatic illustrations showing different adjustment positions of the hydraulic stem deflector mount of FIG. 5A.

While the above-identified figures set forth certain embodiments of the stem deflector mount, other embodiments are also contemplated, as noted in the disclosure. In all cases, this disclosure presents the stem deflector mount by way of representation and not limitation. It should be understood that numerous other modifications and embodiments can be devised by those skilled in the art which fall within the scope and spirit of the principles of this disclosure.

### DETAILED DESCRIPTION OF ILLUSTRATIVE EMBODIMENTS

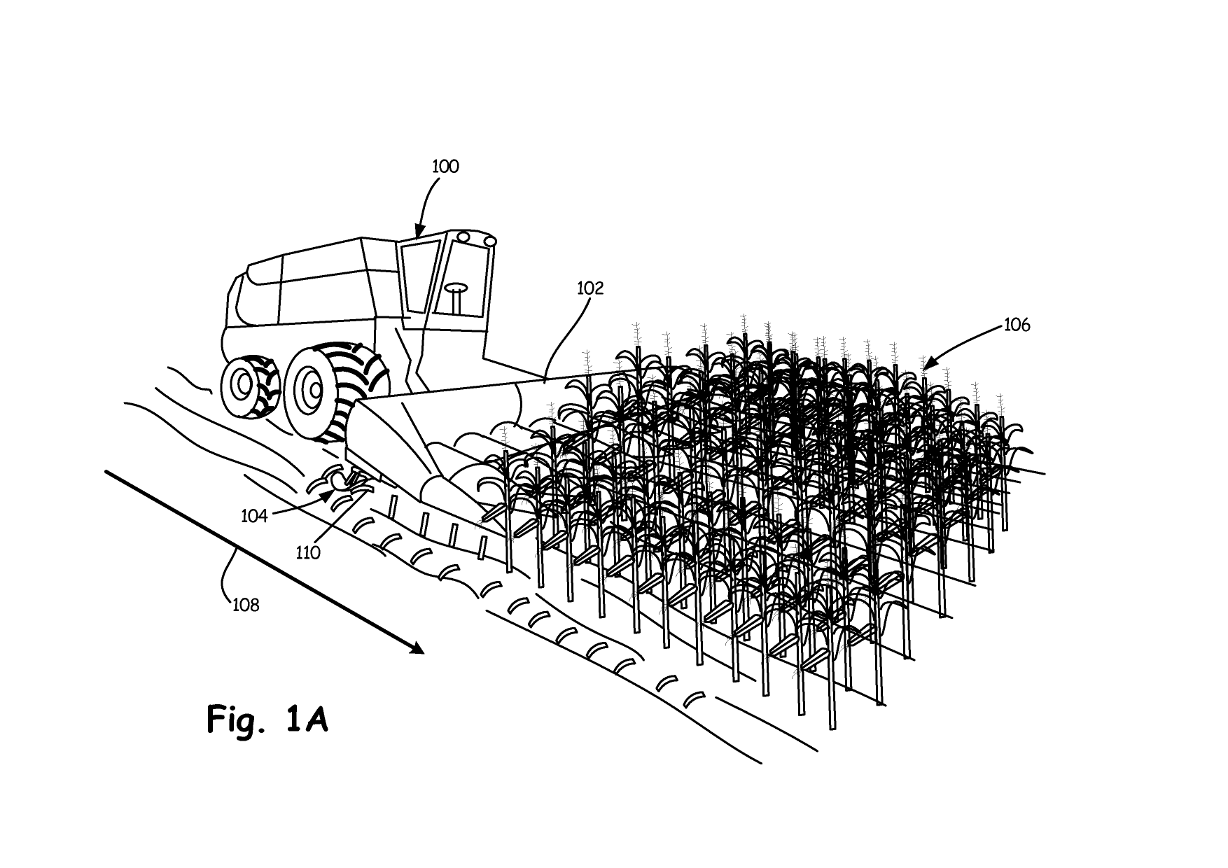

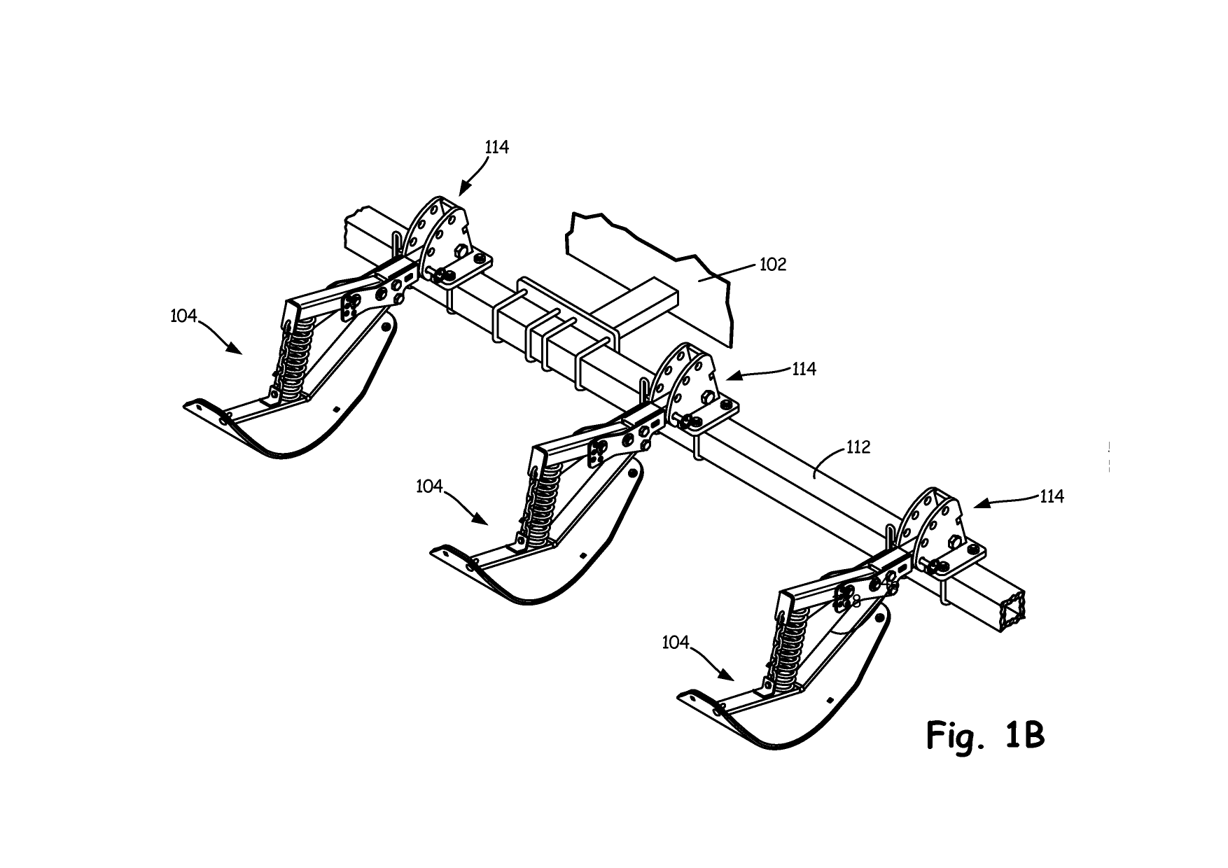

FIG. 1A is a diagrammatic illustration of a combine harvester 100 with a connected head 102 to which a set of stem deflectors 104 is coupled. In FIG. 1, combine harvester 100 is shown harvesting crop (corn, for example) 106 in a direction shown by arrow 108. Stem deflector 104 is shown crushing a stem 110 as the crop is being harvested.

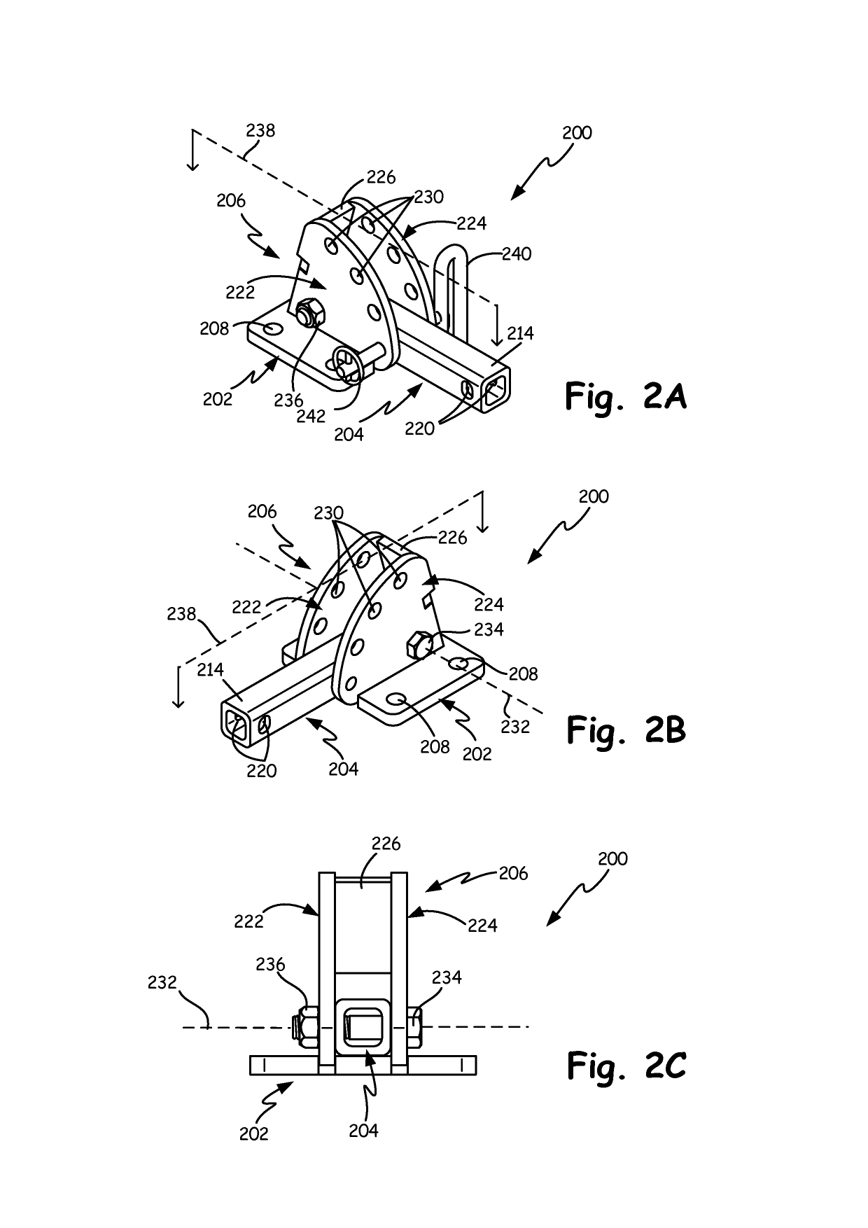

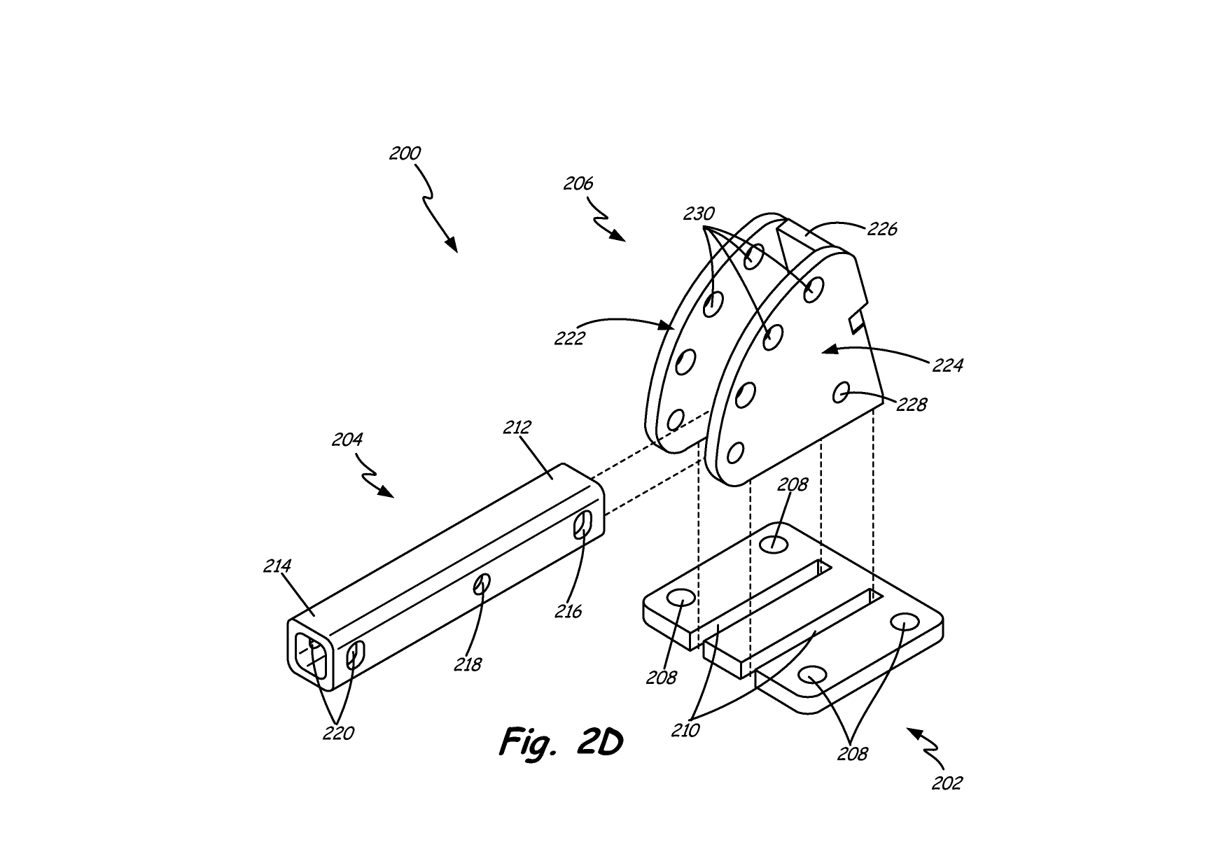

FIG. 1B is a diagrammatic illustration of a portion of a combine head 102 with an attached toolbar 112 to which multiple stem deflectors 104 are rotatably coupled with the help of stem deflector mounts 114, which are described in detail further below. As will be explained in detail further below, stem deflector mounts such as 114 include features that enable a user to, for example, rotate and position the stem deflectors away from trailer axles/tires during transportation of combine head 102 without having to detach the stem deflectors 104 from the toolbar 112. An exemplary embodiment of such a stem deflector mount is described below in connection with FIGS. 2A through 2F.

FIGS. 2A, 2B and 2C show different views of a stem deflector mount 200 in accordance with one embodiment. As can be seen in FIGS. 2A, 2B and 2C, stem deflector mount 200 includes a base 202, a rotatable member (for example, a mounting arm) 204 and an adjustment mechanism 206 for adjusting a position of rotatable member 204 relative to base 202. Stem deflector mount 200 can be coupled either directly, or via a toolbar such as 112 of FIG. 1B, to a combine head (such as 102 of FIGS. 1A and 1B). A stem deflector (such as 104 of FIGS. 1A and 1B) can be connected to rotatable member 204 of stem deflector mount 200.

FIG. 2D is an exploded view, of stem deflector mount 200, showing base 202, rotatable member 204 and adjustment mechanism 206. As can be seen in the example of FIG. 2D, base 202 is a plate that includes mounting holes 208 and slots 210. Mounting holes 208, which are four in number in the exemplary embodiment of FIG. 2D, are capable of receiving fasteners that help attach base 202 to a toolbar (such as 112, which is connected to head 102 shown in FIG. 1B). In one embodiment, the fasteners may be U-bolts that help attach base 202 to toolbar 112. Slots 210, which are two in number in the exemplary embodiment of FIG. 2D, are suitably sized to receive edges of flanges of adjustment mechanism 206, which is described further below. Base 202 may be made of any suitable metal or other material and may be a plate that has a rectangular, square or any other suitable shape.

As can be seen in FIG. 2D, mounting arm 204 has a first end 212 and a second end 214. In some embodiments, mounting arm 204 may be a hollow tube made of any suitable metal or other material and can have any suitable cross-sectional shape, such as rectangular or circular. In other embodiments, mounting arm 204 may be a solid arm made of any suitable metal or other material. As can be seen in FIG. 2D, mounting arm 204 includes coaxially-aligned holes 216, 218 and 220 on opposing sides of hollow arm 204. Holes 216, 218 and 220 receive fasteners (for example, bolts) that couple mounting arm 204 to adjustment mechanism 206 and to a stem deflector such as 104 shown in FIGS. 1A and 1B. It should be noted that, if arm 204 is solid, each of features 216, 218 and 220 includes channels or bores that extend through arm 204. Specifics regarding coupling of arm 204 to adjustment mechanism 206 and to a stem deflector such as 104 of FIGS. 1A and 1B are provided further below.

In the example shown in FIG. 2D, adjustment mechanism 206 includes two opposing flanges 222 and 224 and a connection piece 226 between the opposing flanges 222 and 224. Connection piece 226 holds the opposing flanges 222 and 224 in a spaced apart position. Different sides of connection piece 226 may be welded to opposing flanges 222 and 224, respectively. Any other suitable method of coupling connection piece to flanges 222 and 224 may also be used. Adjustment mechanism 206 may be made of metal or of any other suitable material. In one embodiment, adjustment mechanism 206, mounting arm 204 and base 202 are made of a same material. Adjustment mechanism 206 includes multiple aligned holes such as coupling holes 228 and an array of adjustment holes 230 in flanges 222 and 224. Coupling holes 228 receive a fastener (for example, bolt) for coupling mounting arm 204 to adjustment mechanism 206. Adjustment holes 230, which accept a pin (a bolt, for example), are employed to provide different adjustment positions for mounting arm 204 relative to base 202. Details regarding mounting arm position adjustments are provided further below.

As indicated earlier, stem deflector mount 200 is designed and assembled such that it enables a user to, for example, rotate and position a mounted stem deflector, such as 104 shown in FIGS. 1A and 1B, away form trailer axles/tires during transportation of combine head 102 without having to detach the stem deflector 104 from the toolbar 112 (shown in FIG. 1B). Details regarding how components of stem deflector mount 200 are operably coupled together are provided below.

In the embodiment shown in FIGS. 2A, 2B, and 2C, edges of flanges 222 and 224 of adjustment mechanism 206 are inserted into slots 210 of base 202 and, in some embodiments, the inserted edges of flanges 222 and 224 are permanently joined to base 202 by welding, soldering, brazing or any other suitable procedure. Mounting arm 204 is pivotally coupled to adjustment mechanism 206, using suitable fasteners, along pivot axis 232 (shown in FIGS. 2A, 2B and 2C). Specifically, first end 212 of mounting arm 204 is coupled to adjustment mechanism 206 by a bolt 234 that passes through coaxially aligned coupling holes 228 (shown in FIG. 2D) in adjustment mechanism 206 and along pivot axis 232 (shown in FIGS. 2A, 2B and 2C). Bolt 234 is held in place by, for example, a lock nut 236. In this embodiment, mounting arm 204 is pivotal in a plane 238 (shown in FIGS. 2A and 2B) that is perpendicular to pivot axis 232. In one embodiment, pivotal movement of mounting arm 204 is limited to vertical plane 238. As noted above, opposing flanges 222 and 224 also include aligned adjustment holes 230. As can be seen in FIGS. 2A and 2B, adjustment holes 230 are arranged within planes parallel to vertical plane 238 (shown in FIGS. 2A and 2B). A position/location of mounting arm 204 in vertical plane 238 (shown in FIGS. 2A and 2B) can be adjusted by moving mounting arm 204 about pivot axis 232 (shown in FIGS. 2A, 2B and 2C) and inserting a fastener (for example, a hitch pin 240) through a respective pair of adjustment holes 230 and aligned holes 218 (shown in FIG. 2D) of mounting arm 204. Hitch pin 240 may be secured in place by a lynch pin 242. It should be noted that mounting arm 204 has a range of pivotal travel within vertical plane 238 between base 202 and connection piece 226.

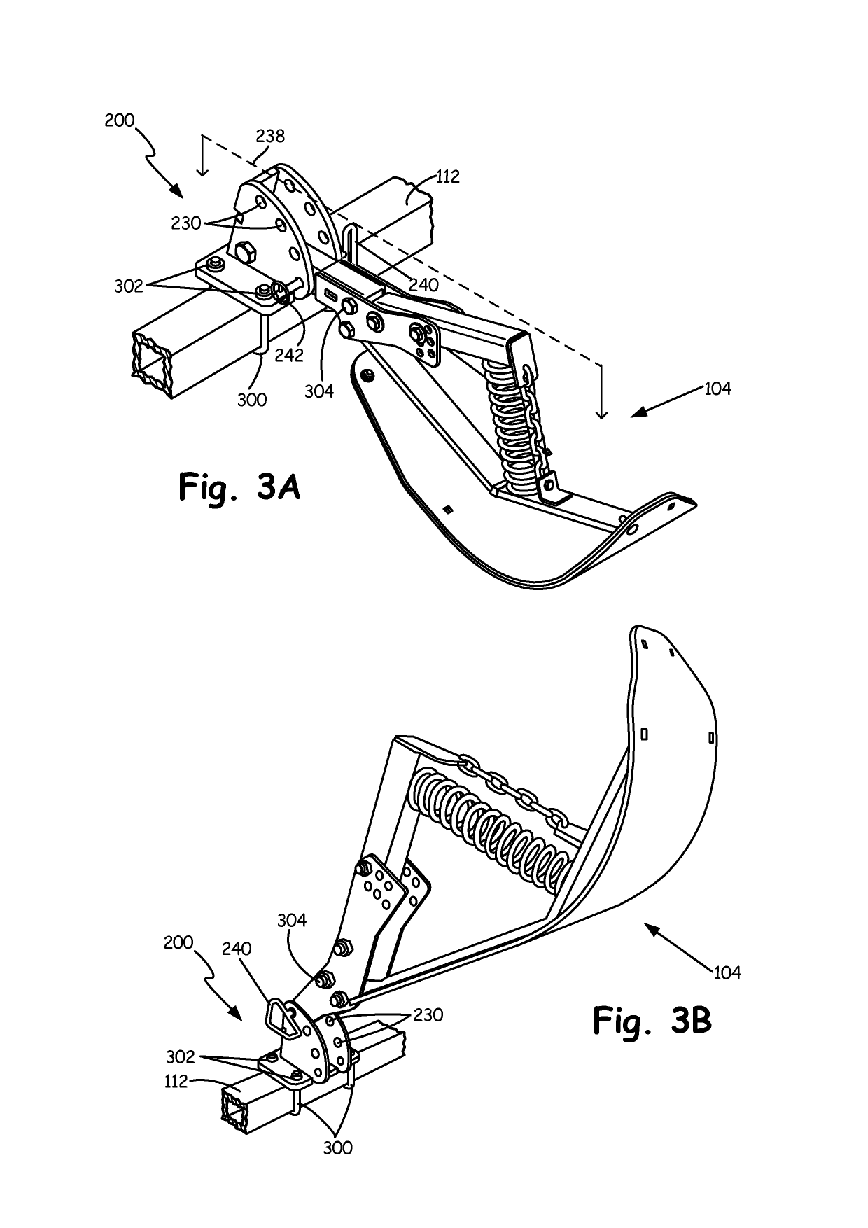

As described above, stem deflector mount 200, with its components operably coupled together, is suitable for mounting a stem deflector (such as 104 of FIGS. 1A and 1B) to a toolbar such as 112, which is connected to head 102 shown in FIGS. 1A and 1B). FIGS. 3A and 3B show a stem deflector mount 200 with its base 202 mounted on toolbar 112 and stem deflector 104 attached to mounting arm 204. Base 202 of stem deflector mount 200 is secured to toolbar 112 by placing base 202 on a desired side of toolbar 112 and positioning U-bolts 300 around toolbar 112 such that threaded ends, for example, of U-bolts 300 pass through mounting holes 208 (shown in FIG. 2D). Nuts 302 are mated to the threaded ends of the U-bolts 300 to form closed clamps.

Stem deflector 104 is coupled to mounting arm 204 by inserting a suitable fastener (for example, a pin) 304 through a pair of coupling holes (not shown) in stem deflector 104 and aligned holes 220 (shown in FIG. 2D) at second end 214 of mounting arm 204. It should be noted that stem deflector mount 200 can be mounted either on top of, or under, toolbar 112 to achieve suitable positioning of stem deflector 104 for bending/crushing stems. As indicated above, by adjusting a position/location of mounting arm 204 in vertical plane 238 (shown in FIGS. 2A and 2B) stem deflector 104 may be positioned either for deflecting stems, or rotated to a different position to, for example, position stem deflector 104 away form trailer axles/tires during transportation of combine head 102 (shown in FIGS. 1A and 1B). As indicated above, repositioning of stem deflector 104 from, for example, a first position shown in FIG. 3A to a second position shown in FIG. 3B can be carried out by, in the first position, detaching lynch pin 242 from hitch pin 240, removing hitch pin 240 from a current set of adjustment holes 230 and aligned holes 218, rotating mounting arm 204 to the second position, inserting hitch pin 240 through different adjustment holes 230 and aligned holes 218 (shown in FIG. 2D) and securing hitch pin 240 with lynch pin 242 in the second position.

In the exemplary embodiments of the stem deflector described above, two flanges 222 and 224 are included in adjustment mechanism 206. However, in some embodiments only one flange may be employed. Also, any suitable clamping mechanism may be used to hold mounting arm 204 in place. In some embodiments, instead of employing an adjustment mechanism such as 206 that includes flanges 222 and 224 with adjustment holes 230, any suitable lifting mechanism (for example, a hydraulic lift mechanism) may be used to move mounting arm 204 to different positions and hold mounting arm 204 in place. In some embodiments, base 202 and adjustment mechanism 206 are welded together at the time of manufacture of stem deflector mount 200. The welding is carried out at a region where edges of the pair of flanges 222 and 224 of adjustment mechanism 206 are inserted into slots 210 of base 202. In other embodiments, base 202 and adjustment mechanism 206 are integrally formed together at the time of manufacture. In still other embodiments, edges of the pair of flanges 222 and 224 of adjustment mechanism 206 are inserted into slots 210 of base 202 by an end user. In general, any suitable mechanism for connecting adjustment mechanism 206 and base 202 may be employed.

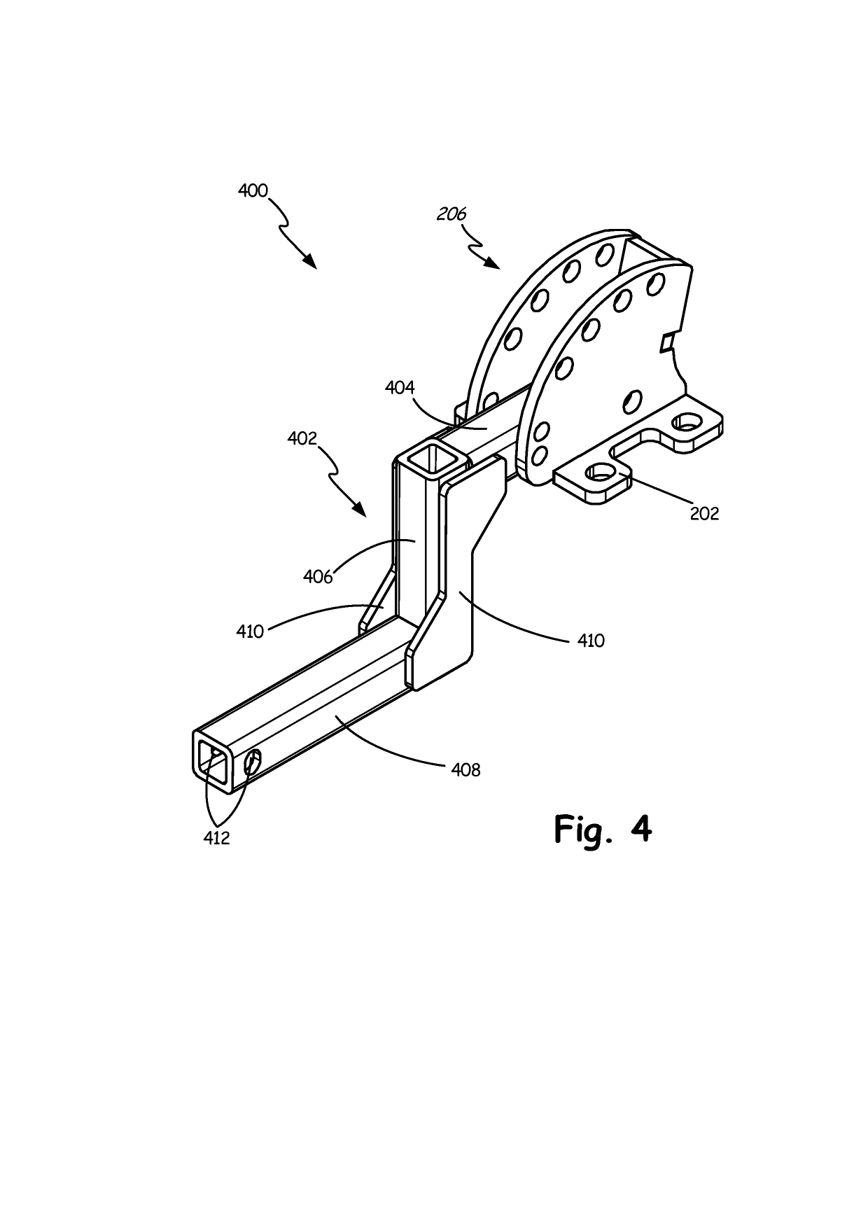

In the embodiments of stem deflector mount 200 described above, rotatable mounting arm 204 is shown as a single straight hollow tube that includes coaxially-aligned holes 216, 218 and 220 on opposing sides of hollow tube 204. As noted above, holes 216, 218 and 220 receive fasteners that couple mounting arm 204 to adjustment mechanism 206 and to a stem deflector such as 104 shown in FIGS. 1A and 1B. In some stem deflector mount embodiments, instead of a single straight hollow tube, the mounting arm may include bent or angled features and may be formed of multiple pieces. One such embodiment is shown is described below in connection with FIG. 4.

FIG. 4 is a diagrammatic illustration of a stem deflector mount 400, which includes rotatable mounting arm 402 in accordance with one embodiment. Elements other than mounting arm 402 in stem deflector mount 400 are substantially similar to the elements of stem deflector mount 200. The description of the substantially similar elements is not repeated in connection with FIG. 4. As can be seen in FIG. 4, rotatable mounting arm 402 includes three pieces or sections 404, 406 and 408 at right angles to each other. Piece 404 is a first end piece, which is a hollow tube that includes coaxially-aligned holes (not shown) on opposing sides of the hollow tube. The holes receive fasteners that couple rotatable mounting arm 402 to adjustment mechanism 206. Middle piece 406, which is between first end piece 404 and second end piece 408, is a hollow tube that is held in place by flanges 410, which are positioned on opposing sides of middle piece 406. Flanges 410 may be welded to portions of pieces 404, 406 and 408. Second end piece 408, which is also a hollow tube, includes coaxially-aligned holes 412 on opposing sides of piece 408. Holes 412 receive fasteners that couple rotatable mounting arm 402 to a stem deflector such as 104 shown in FIGS. 1A and 1B. It should be noted that, instead of flanges 410, any other suitable connection technique may be used to couple pieces 404, 406 and 408 together. This can include designing pieces 404, 406 and 408 such that one or more ends of one piece fit into one or more corresponding ends of one or more other pieces. In some embodiments, rotatable mounting arm 402 may be a single piece shaped as shown in FIG. 4. Hollow tubes 404, 406 and 408 of rotatable mounting arm 402 may be made of any suitable metal or other material and can have any suitable cross-sectional shape, such as rectangular or circular. In some embodiments, one or more of pieces 404, 406 and 408 may be solid instead of hollow.

With rotatable mounting arm 402 positioned as shown in FIG. 4, piece 408, on which a stem deflector such as 104 is mounted, is substantially below base 202. This is in contrast with mounting arm 204 of stem deflector mount 200, which does not include any portions below base 202 in the corresponding position shown in FIG. 2A. Thus, employing mounting arm 402 enables a user to position stem deflector 104 closer to the earth and thereby provides stronger biasing of stem deflector 104 against the earth for bending or crushing stems.

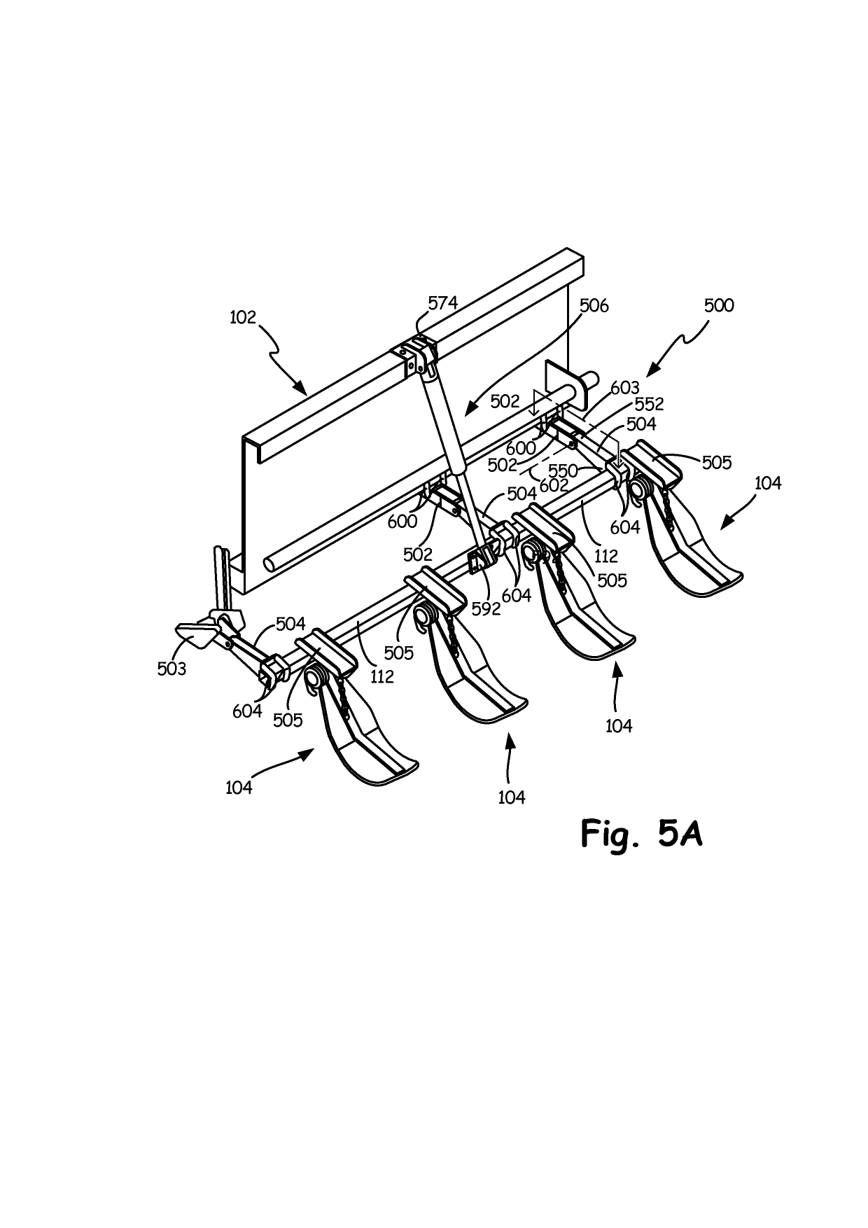

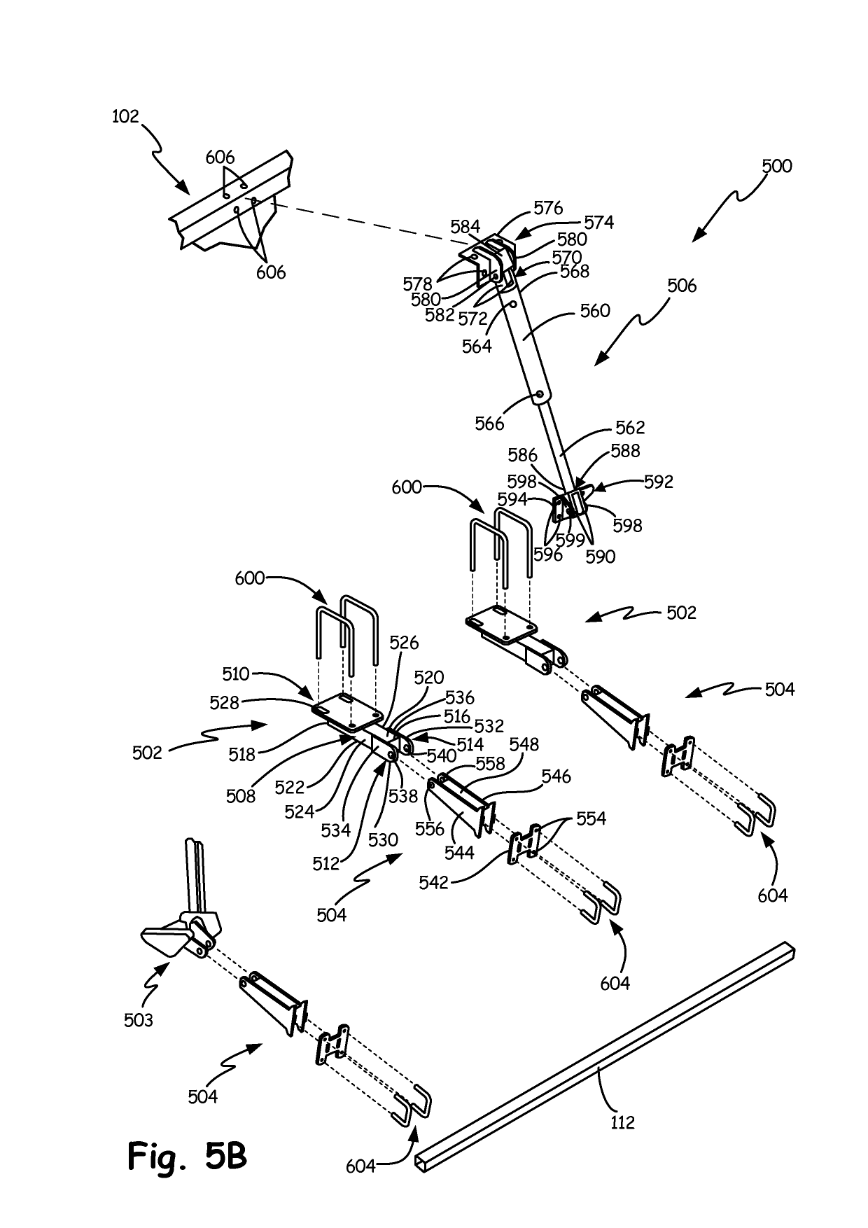

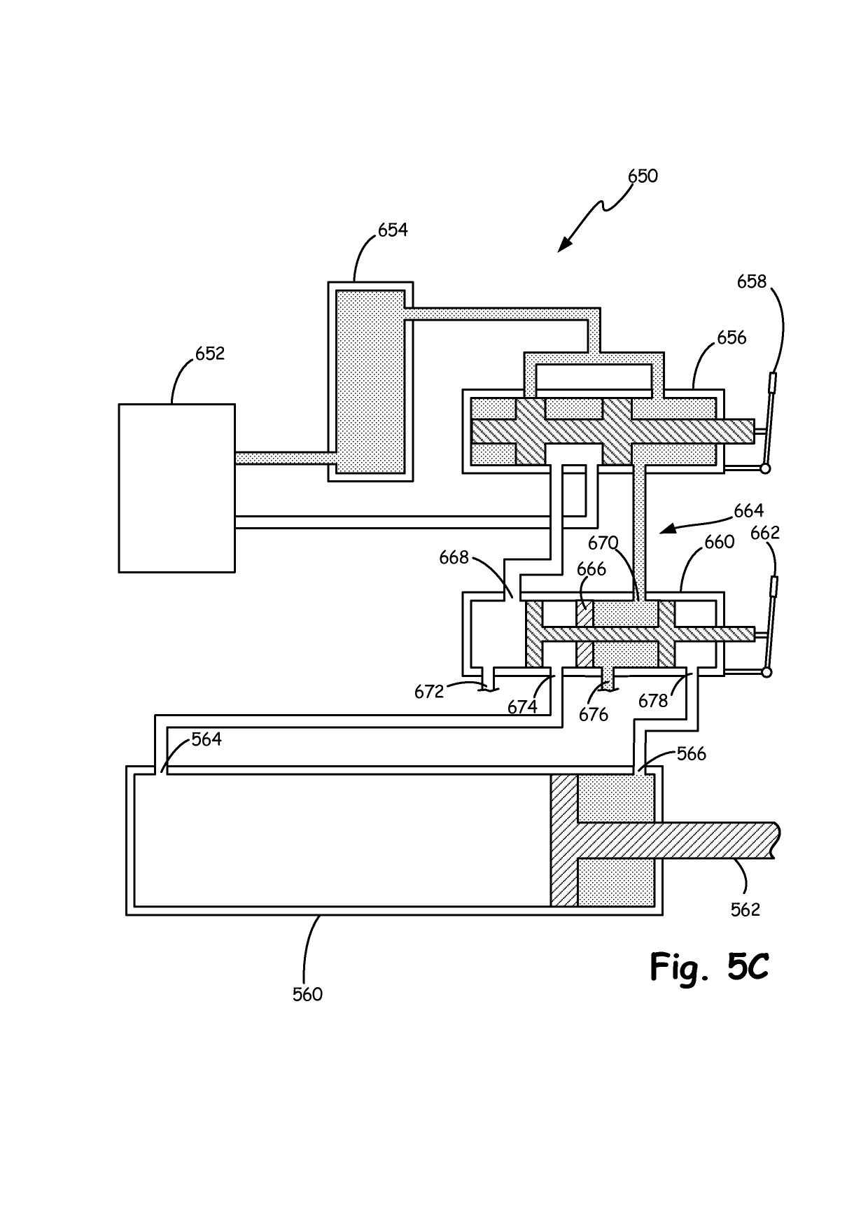

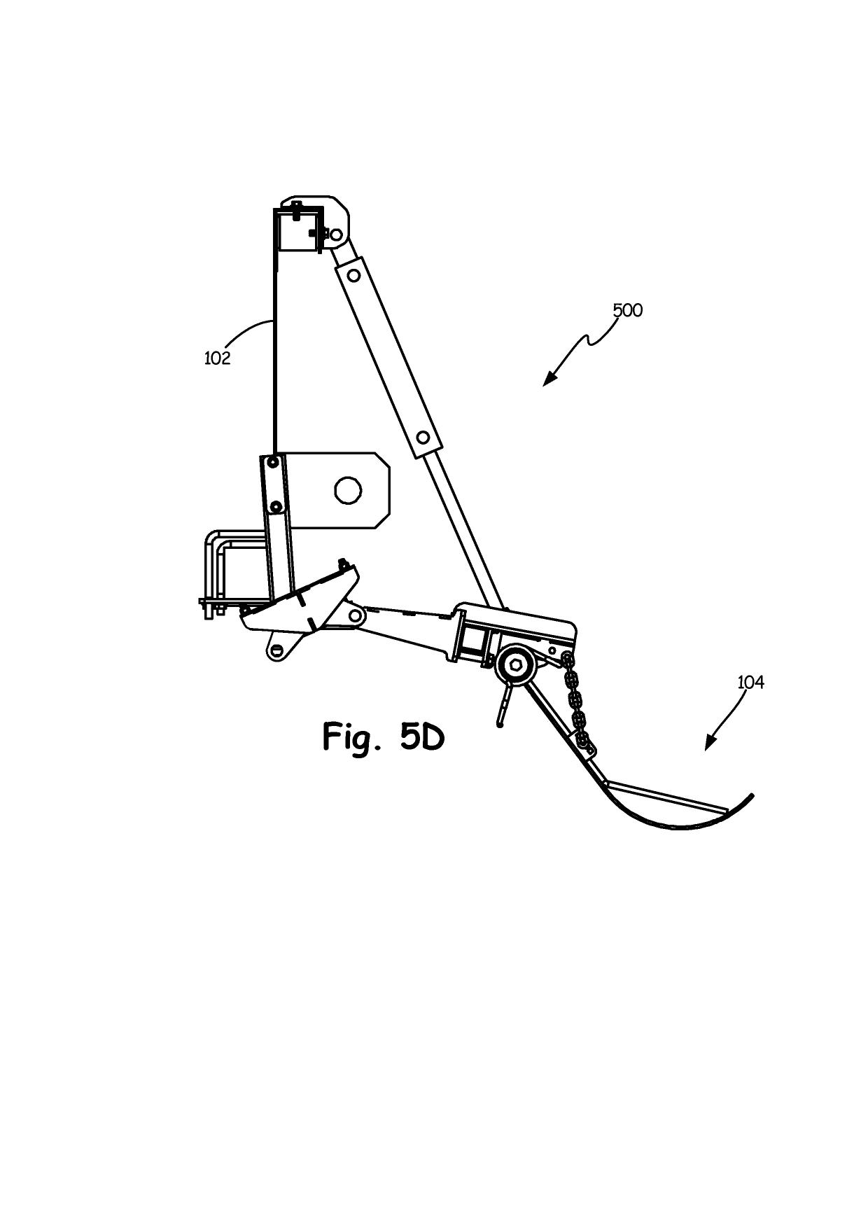

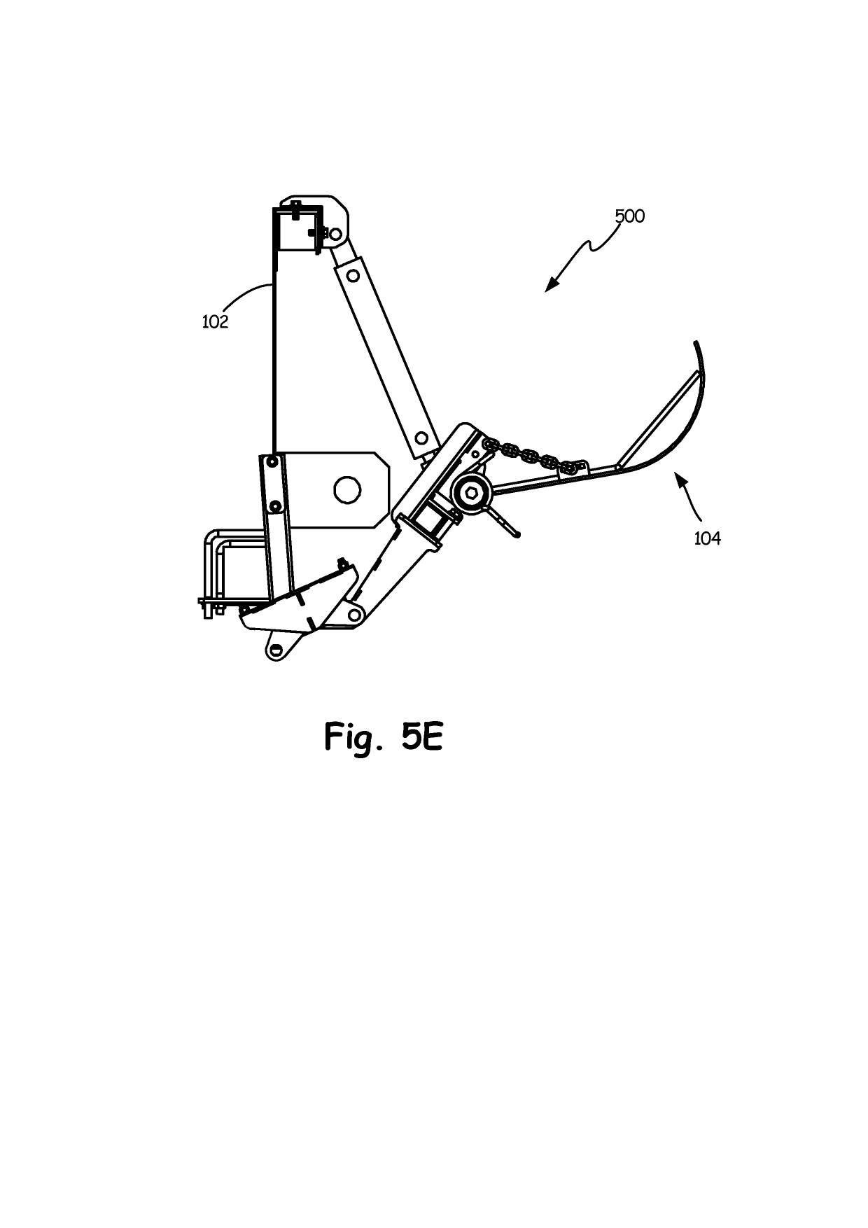

The above-described stem deflector mount embodiments relate to mounting of a single stem deflector on a corresponding single stem deflector mount. Thus, in such embodiments, a separate stem deflector mount is needed for each stem deflector and each stem deflector mount has to be separately adjusted to move a stem deflector from a first position (for example, a working position) to a second position (for example, a transport position). In some embodiments, a stem deflector mount that is capable of simultaneously moving multiple stem deflectors from a first position to a second position is provided. One such stem deflector mount is described below in connection with FIGS. 5A-5E.

FIG. 5A is a diagrammatic illustration of a portion of a combine head 102 to which a hydraulic stem deflector mount 500, in accordance with one embodiment, is coupled. As can be seen in FIG. 5A, hydraulic stem deflector mount 500 is also coupled to a toolbar 112 on which multiple stem deflectors 104 are mounted. As will be explained in detail below, hydraulic stem deflector mount 500 includes features that enable a user to, for example, simultaneously rotate and position the multiple stem deflectors 104 away from trailer axles/tires during transportation of combine head 102 by adjusting a position of toolbar 112.

To adjust a position of toolbar 112, hydraulic stem deflector mount 500 includes one or more head brackets 502, one or more rotatable members (for example, swivel brackets) 504 and an adjustment mechanism (for example, a hydraulic actuator) 506 for adjusting the position of the rotatable member(s) 504 relative to the combine head 102. As can be seen in FIG. 5, hydraulic stem deflector mount 500 is coupled to both combine head 102 and to toolbar 112 to which the multiple stem deflectors 104 are coupled.

FIG. 5B is an exploded view of hydraulic stem deflector mount 500 showing one or more head brackets 502, one or more rotatable members (for example, swivel brackets) 504 and an adjustment mechanism (for example, a hydraulic actuator) 506 for adjusting the position of the rotatable member(s) 504 relative to the combine head 102. As can be seen in FIG. 5B, head bracket 502 includes a hollow tube 508, a head connection plate 510 and opposing flanges 512 and 514. Head bracket 502 may be made of metal or any other suitable material. Hollow tube 508 has a first end 516, a second end 518, an outer top surface 520 an outer bottom surface 522 and opposing outer side surfaces 524 and 526. Head connection plate 510 includes mounting holes 528, which are four in number in one exemplary embodiment. Mounting holes 528 are capable of receiving fasteners that help attach head bracket 502 to combine head 102. Each of opposing flanges 512 and 514 includes a first portion 530, 532 and a second portion 534, 536. First portions 530 and 532 include holes 538 and 540, respectively, for receiving fasteners that help couple head bracket 502 to rotatable member 504. As can be seen in FIG. 5B, head connection plate 510 is attached (for example, welded) to outer top surface 520 of hollow tube 508 proximate the second end 518 of the hollow tube 508. Also, second portions 534 and 536 of flanges 512 and 514 are attached (for example, welded) to opposing outer side surfaces 524 and 526, respectively, of hollow tube 508 proximate the first end 516 of the hollow tube 508. Holes 538 and 540 in flanges 512 and 514, respectively, are coaxially aligned. In some embodiments, tube 508 may be a solid tube.

In the exemplary embodiment shown in FIG. 5B, rotatable member (for example, swivel bracket) 504 has a toolbar connection plate 542, opposing flanges 544 and 546 and a connection piece 548 between the opposing flanges 544 and 546. Connection piece 548 holds the opposing flanges 544 and 546 in a spaced-apart position. Different sides of connection piece 548 may be welded to opposing flanges 544 and 546, respectively. Any other suitable method of coupling connection piece 548 to flanges 544 and 546 may also be used. Toolbar connection plate 542, which is positioned at a first end 550 (shown in FIG. 5A) of rotatable member 504, is similar to head connection plate 510 of head bracket 502 and includes mounting holes 554, which are four in number in one exemplary embodiment. Mounting holes 554 are capable of receiving fasteners that help couple rotatable member 504 to toolbar 112. Rotatable member 504 may be made of metal or of any other suitable material. In one embodiment, head bracket 502 and rotatable member 504 are made of a same material. Rotatable member 504 also includes coaxially-aligned coupling holes 556 and 558 at its second end 552 (shown in FIG. 5A). Coupling holes 556 and 558 receive a fastener (for example, bolt) for coupling rotatable member 504 to head bracket 502.

The embodiment shown in FIGS. 5A and 5B also includes adjustment mechanism (for example, a hydraulic actuator including a hydraulic cylinder assembly) 506. Hydraulic cylinder assembly 506 includes a hydraulic cylinder 560 and a rod 562 that performs reciprocating movement in cylinder 560 in response to fluid pressure applied within the cylinder 560. Fluid enters/exits into/from cylinder 560 through ports 564 and 566. In one embodiment, hydraulic cylinder assembly 506 is a double-acting hydraulic cylinder, which is described further below in connection with FIG. 5C. Of course, other types of hydraulic cylinders such as single-acting hydraulic cylinders may also be employed. As can be seen in FIG. 5B, a cylinder end 568 of assembly 506 includes a cylinder end piece 570 with flanges 572 that include coaxially-aligned holes (not shown). A cylinder-head connection bracket 574 is employed to couple cylinder end 568 of hydraulic cylinder assembly 506 to head 102. Cylinder-head connection bracket 574 includes a right-angled mounting plate 576 that includes holes 578 that receive fasteners for coupling right-angled mounting plate 576 to head 102. Cylinder-head connection bracket 574 also includes opposing flanges 580 that extend from right-angled mounting plate 578. Flanges 580 include coaxially-aligned holes 582 that correspond to the holes (not shown) in flanges 572. Flanges 580 are held in a spaced-apart position by connection piece 584, which may be welded to flanges 580. Further, as can be seen in FIGS. 5A and 5B, a rod end 586 of assembly 506 includes a rod-end piece 588, which is similar to cylinder end piece 570. Rod-end piece 588 includes flanges 590 that include coaxially aligned holes (not shown). A rod-toolbar connection bracket 592 is employed to couple rod end 586 of hydraulic cylinder assembly 506 to toolbar 112. Rod-toolbar connection bracket 592 includes a mounting plate 594 that includes holes 596 that receive fasteners for coupling mounting plate 594 to toolbar 112. In one embodiment, the fasteners may be U-bolts that help attach mounting plate 594 to toolbar 112. Rod-toolbar connection bracket 592 also includes opposing flanges 598 that extend from mounting plate 594. Flanges 598 include coaxially-aligned holes 599 that correspond to holes (not shown) in flanges 590.

As indicated earlier, hydraulic stem deflector mount 500 is designed and assembled such that it enables a user to, for example, simultaneously rotate and position multiple stem deflector, such as 104 shown in FIGS. 1A and 1B, away form trailer axles/tires during transportation of combine head 102. Details regarding how components of hydraulic stem deflector mount 500 are operably coupled together are provided below.

In the embodiment shown in FIGS. 5A and 5B, U-bolts 600 are inserted into holes (not shown) in head 102 and into mounting holes 528 of head connection plate(s) 510 of head bracket(s) 502. Nuts (not shown) are mated to threaded ends of U-bolts 600 to form closed clamps. Swivel bracket(s) 504 is pivotally coupled to head bracket(s) 502, using suitable fasteners, along a pivot axis 602. Specifically, coupling holes 556 and 558 at second end 552 of swivel bracket(s) 504 are aligned with holes 538 and 540 in flanges 512 and 514 of head bracket 502 and a bolt (not shown) is passed through the aligned holes 538, 540, 556 and 558 along pivot axis 602. The bolt is held in place by, for example, a lock nut (not shown). First end 550 of rotatable member 504, is secured to toolbar 504 by placing toolbar connection plate 542 on a desired side of toolbar 112 and positioning U-bolts 604 around toolbar 112 such that threaded ends, for example, of U-bolts 604 pass through mounting holes 554. Nuts (not shown) are mated to the to the threaded ends of U-bolts 604 to form closed clamps.

As noted above, rod end 586 of hydraulic cylinder assembly 506 is connected to toolbar 112 via rod-toolbar connection bracket 592. Holes 599 in rod-toolbar connection bracket 592 are aligned with holes (not shown) in flanges 590 and a bolt (not shown) is passed through the aligned holes. The bolt is held in place by, for example, a lock nut (not shown). Mounting plate 594 of rod-toolbar connection bracket 592 is placed on a desired side of toolbar 112 and U-bolts (not shown) are positioned around toolbar 112 such that the threaded ends, for example, of the U-bolts pass through holes 596 in mounting plate 594. Nuts (not shown) are mated to threaded ends of the U-bolts to form closed clamps. As indicated above, cylinder end 568 of hydraulic cylinder assembly 506 is connected to head 102 via cylinder-head connection bracket 574. Holes 582 in cylinder-head connection bracket 574 are aligned with holes (not shown) in flanges 572 and a bolt (not shown) is passed through the aligned holes. The bolt is held in place by, for example, a lock nut (not shown). Right-angled mounting plate 576 is positioned on head 102 such that holes 606 in head 102 are aligned with holes 578 in the right-angled mounting plate 576, and bolts (not shown) are inserted into the aligned holes. The bolts are held in place by, for example, lock nuts (not shown). It should be noted that hydraulic stem deflector mount 500 may include a head end bracket 503, which may differ in shape from head brackets 502 and may be connected to a different portion of head 102 than the portion of head 102 to which head brackets 502 are connected. However, head end bracket 503 is connected to a particular one of swivel brackets 504 in a manner similar to which head brackets 502 are connected to other ones of swivel brackets 504. Also, head end bracket 503 includes elements such as flanges, plates, etc., which are similar to those included in head brackets 502, but only arranged differently. Therefore, in the interest of simplification, a separate description of individual elements of head end bracket 503 has not been provided. Also, in the in the interest of simplification, no detailed description of connection members 505, which couple stem deflectors 104 to toolbar 112, has been provided. In this embodiment, mounting arm 504 is pivotal in a plane 603 (shown in FIG. 5A) that is perpendicular to pivot axis 602. It should be noted that, although several elements of hydraulic stem deflector mount 500 include two opposing flanges with coaxially-aligned holes, in some embodiments, one or more of such elements may include only a single flange with one or more holes for receiving fasteners.

FIG. 5C is a diagrammatic illustration of a hydraulic actuator control system 650 that controls hydraulic cylinder assembly 506. As can be seen in FIG. 5C, actuator control system 650 includes a pump 652, a hydraulic fluid tank 654, a directional control valve 656, a directional control valve handle 658, a selector valve 660, a selector valve handle 662 and a pipe/tube system 664. An engine (not shown) is operably coupled to pump 652 and provides power for actuator control system 650. The engine and elements 652, 654, 656 and 658 may be located in the combine harvester 100 (shown in FIG. 1A) and elements 660 and 662 may be located at any suitable position on head 102. Selector valve 660, which is separated into two sections by separation element 666, includes a plurality of ports 668, 670, 672, 674, 676 and 678. Ports 668 and 670 are connected to directional control valve 656. Ports 674 and 678 are connected to ports 564 and 566, respectively, of cylinder 560. Ports 672 and 676 are connected to other hardware, which is not described in the interest of simplification. Pipe/tube system 664 interconnects different elements by connecting to the various ports shown in FIG. 5C.

Hydraulic fluid tank 654 is formed of a suitable material that is capable storing hydraulic oil, for example. A user may operate directional control valve 656 by adjusting a position of handle 658, which is operably coupled to directional control valve 656. Similarly, separator valve 660 may be operated by adjusting handle 662 to a first position in which ports 672 and 676 and blocked and ports 674 and 678 are open, or to a second position in which ports 674 and 678 are blocked and ports 672 and 676 are open. When handle 662 is in the second position, rod 562 remains in a particular position within cylinder 560.

In operation, tank 654 feeds hydraulic fluid to pump 652. Pump 652, which is run by the engine, creates a stream of high-pressure hydraulic fluid that runs to directional control valve 656. By adjusting a position of handle 658, the user can direct the high-pressure hydraulic fluid to either port 668 or to port 670 of separator valve 660. When separator valve 660 is adjusted to be in the first position, high-pressure hydraulic fluid enters port 668 of separator valve 660 and then enters hydraulic cylinder 560 through port 564. This results in rod 562 moving out of cylinder 560 and thereby moves stem deflectors to a working position shown in FIG. 5D. As noted above, in the working position, stem deflectors 104 bend or crush stems as the combine travels in a forward direction. When handle 658 of directional control valve 656 is positioned such that high-pressure hydraulic fluid enters port 670 of separator valve 660 and then enters hydraulic cylinder 560 through port 566, rod 562 moves into cylinder 560 and thereby moves stem deflectors to a transport position shown in FIG. 5E. As noted above, in the position shown in FIG. 5E, when the head 102 with the mounted stem deflectors 104 is placed on a trailer, no stem deflectors interfere with axles/tires of the trailer. It should be noted that hydraulic actuator control system 650 is also capable of positioning stem deflectors 104 in intermediate positions, which may be any suitable positions between those shown in FIGS. 5D and 5E. Also, in some embodiments, the working position is not a single position, but includes multiple adjustment positions, each of which may be suitable for a harvesting a different crop and/or a different earth surface condition, for example.

It is to be understood that even though numerous characteristics and advantages of various embodiments have been set forth in the foregoing description, together with details of the structure and function of various embodiments, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the stem deflector mount while maintaining substantially the same functionality without departing from the scope and spirit of the present disclosure.

What is claimed is:

1. An apparatus for rotatably mounting at least one stem deflector to a combine head, the apparatus comprising:
at least one head bracket configured to attach to the combine head; and
at least one rotatable member coupled to the at least one head bracket and the at least one stem deflector, wherein a position of the at least one rotatable member is adjustable relative to the combine head, and
a hydraulic actuator configured to couple to the combine head and configured to couple to the at least one stem deflector, the hydraulic actuator configured to adjust the position of the at least rotatable member relative to the combine head.

2. The apparatus of claim 1 and wherein the at least one rotatable member comprises a swivel bracket having a first end and a second end, and wherein the first end of the swivel bracket is pivotally coupled to the at least one head bracket about a pivot axis, and wherein the swivel bracket is pivotal in a plane that is perpendicular to the pivot axis.

3. The apparatus of claim 2 and wherein the at least one stem deflector comprises a plurality of stem deflectors mounted on a toolbar.

4. The apparatus of claim 3 and wherein the at least one rotatable member is configured to couple to the toolbar, and wherein the hydraulic actuator is configured to couple to the toolbar.

5. The apparatus of claim 4 and wherein the hydraulic actuator comprises a hydraulic cylinder assembly.

6. The apparatus of claim 4 and wherein the hydraulic cylinder assembly comprises a double-acting cylinder.

7. The apparatus of claim 5 and wherein the hydraulic cylinder assembly comprises a cylinder end and a rod end and wherein the cylinder end is coupled to the combine head and wherein the rod end is coupled to the toolbar.

8. The apparatus of claim 1 and wherein the hydraulic actuator is configured to adjust the position of the at least rotatable member relative to the combine head to a plurality of adjustment positions for the at least one stem deflector.

9. The apparatus of claim 8 and wherein the plurality of adjustment positions comprises a transport position and at least one working position.

10. The apparatus of claim 9 and wherein the at least one working position comprises a plurality of working positions.

11. A method of attaching a toolbar with at least one mounted stem deflector to a combine head, the method comprising:
rotatably coupling the toolbar to the combine head through a rotatable member; and
providing a hydraulic actuation mechanism to move the rotatable member through a plurality of adjustment positions.

12. The method of claim 11 wherein rotatably coupling the toolbar to the combine through the rotatable member comprises:
coupling a first end of the rotatable member to a head bracket attached to the combine head;
coupling a second end of the rotatable member to the toolbar.

13. The method of claim 12 and further comprising coupling the hydraulic mechanism to the toolbar and to the head.

14. The method of claim 12 and wherein coupling the first end of the rotatable member to the head bracket comprises pivotally coupling the first end of the rotatable member to the head bracket about a pivot axis that is parallel to the toolbar.

15. The method of claim 14 and wherein the rotatable member is pivotal in a plane that is perpendicular to the pivot axis.

16. An apparatus that attaches to a combine head, the apparatus comprising:
a toolbar;
at least one stem deflector mounted on the toolbar;
at least one head bracket configured to attach to the combine head;
at least one rotatable member coupled to the head bracket and coupled to the toolbar, wherein a position of the at least one rotatable member is adjustable relative to the combine head, and
an actuator coupled to the toolbar and configured to couple to the combine head, the actuator configured to adjust the position of the at least rotatable member relative to the combine head by adjusting a position of the toolbar.

17. The apparatus of claim 16 and wherein the at least one rotatable member comprises a swivel bracket having a first end and a second end, and wherein the first end of the swivel bracket is pivotally coupled to the at least one head bracket about a pivot axis, and wherein the swivel bracket is pivotal in a plane that is perpendicular to the pivot axis.

18. The apparatus of claim 16 and wherein the actuator comprises a hydraulic cylinder assembly.

19. The apparatus of claim 18 and wherein the hydraulic cylinder assembly comprises a double-acting cylinder.

20. The apparatus of claim 18 and wherein the hydraulic cylinder assembly comprises a cylinder end and a rod end and wherein the cylinder end is configured to couple to the combine head and wherein the rod end is coupled to the toolbar.
